(19) United States
(12) Patent Application Publication
(10) Pub. No.: US 2012/0222822 A1
(43) Pub. Date: Sep. 6, 2012

(54) Locking Spacer and Method

(75) Inventors: William A. Jones, West Midlands (GB); Stuart J. Hassell, West Midlands (GB)

(73) Assignee: Davian Enterprises, LLC, Greenback, TN (US)

(21) Appl. No.: 13/224,437

(22) Filed: Sep. 2, 2011

Related U.S. Application Data
(60) Provisional application No. 61/379,455, filed on Sep. 2, 2010.

(51) Int. Cl. B29D 30/24; B32B 3/06

(52) U.S. Cl. 156/415; 428/174; 428/156; 428/99

(57) ABSTRACT

A locking spacer for use with a tire building drum is disclosed. The locking spacer includes an arcuate panel having an outer surface, an inner surface, opposite first and second curved side surfaces, and opposite first and second straight end surfaces. The panel is sized and shaped to span between and extend along the opposing inner surfaces of the segments. A first fastener is disposed along the first side surface and is configured to secure the first side surface to a first of the pair of segments, and a second fastener is disposed along the second side surface and is configured to secure the second side surface to a second of the pair of segments. The first and second fasteners limit movement of the first and second side surfaces in relation to the segments along a radial direction of the tire building drum.

### CROSS-REFERENCE TO RELATED APPLICATIONS

This application claims the benefit of U.S. Provisional Patent Application No. 61/379,455, filed on Sep. 2, 2010.

### STATEMENT REGARDING FEDERALLY SPONSORED RESEARCH OR DEVELOPMENT

Not Applicable

### BACKGROUND OF THE INVENTION

1. Field of Invention

This invention pertains to tire building equipment. More particularly, this invention pertains to a locking spacer for an expandable and collapsible tire building drum useful, for example, in the manufacture of tires.

2. Description of the Related Art

Commonly, the process of manufacturing a tire, such as a motor vehicle tire, includes fabrication of a cylindrical carcass as a precursor to the tire. A tire carcass is formed by laying down components of the tire on an outer circumferential working surface of a rotatable, expandable and collapsible drum. The outer circumferential working surfaces of such drums must be adjustable with respect to their diameter, first, to establish the desired outer circumferential working surface of the drum, and second, to collapse the working surface of the drum for removing a completed carcass from the drum. Furthermore, the outer circumferential working surfaces of such drums are often adjustable with respect to their length in order to provide for the formation of various sizes of tire carcasses on a single drum.

Adjustablility of the diameter of tire building drums commonly involves a plurality of segments which are moveable between radially collapsed positions internally of the drum and radially expanded positions in which the segments collectively define the outer circumference of the drum. U.S. Pat. No. 6,390,166 (“the '166 patent”), which patent is incorporated herein in its entirety by reference, discloses a tire building drum of this type. The device of the '166 patent includes generally a plurality of segments collectively defining the outer circumferential surface of a generally cylindrical drum. The segments are mounted by way of a system of linkages about a central main shaft which allows the segments to be selectively repositionable between an expanded position radially of the rotational axis of the drum and a collapsed position radially of the drum in which a portion of the segments are brought into overlying relationship with other of the segments to collapse the diameter of the drum. Positioning the segments in the expanded position provides a relatively continuous circumferential outer surface of the drum, thereby permitting layup of various components of a tire carcass thereon for forming of the tire carcass. Positioning the segments in the collapsed position collapses the diameter (and circumference) of the drum to permit the removal of a formed tire carcass from the drum.

Additionally, the plurality of segments of the '166 patent are divided into two sets, one set being disposed on each of the opposite sides of a transverse centerplane of the drum, the centerplane being oriented normal to the rotational axis of the drum. The two sets of segments are mounted for selective simultaneous movement thereof axially along the drum toward and away from one another to adjust the overall working width of the drum. Each segment of one set is aligned in parallel relationship with a segment of the other set along an axial dimension of the drum. Upon axial separation of the two sets of segments, the circumferential space between the sets of segments at the transverse center plane of the drum is closed by a set of spacers, with each spacer overlying and extending between opposing inner edges of cooperating, axially-aligned segments of the first and second set of segments. In the device of the '166 patent, a central portion of each spacer is secured to a cooperating connector bracket by a plurality of screws, the connector bracket forming a portion of the system of linkages by which each pair of axially-aligned segments of the first and second set of segments are radially expandably and collapsably mounted about the central axis of the drum. Thus, each spacer remains generally fixed between the opposing inner edges of a pair of axially-aligned segments of the first and second set of segments throughout radial expansion and contraction of the segments.

Unintended small displacement or flexure of the spacers in relation to the segments of the drum can result in a non-uniform working surface of the drum, thereby resulting in nonuniform tire carcass development. Furthermore, the process of securing each spacer of the '166 patent to its respective connector bracket using the plurality of screws is often laborious and time consuming. Thus a need in the art exists for innovative systems to increase stability of the spacers in relation to the remaining circumferential working surface of the drum while also allowing for faster and easier fastening of the spacers to the drum.

### BRIEF SUMMARY OF THE INVENTION

Several features of the present general inventive concept include a locking spacer for use with a tire building drum of the type having a pair of arcuate segments aligned in parallel-planar relationship along an axial dimension of the drum, with the pair of segments having opposing inner surfaces and the segments being repositionable with respect to one another along an axial dimension of the tire building drum. In such tire building drums, a connector bracket is disposed between and radially inwardly of the pair of segments. According to one embodiment, the locking spacer comprises an arcuate panel having an outer surface, an inner surface, opposite first and second curved side surfaces, and opposite first and second straight end surfaces. The panel is sized and shaped to span between and extend along the opposing inner surfaces of the segments. A first fastener is disposed along the first side surface and is configured to secure the first side surface to a first of the pair of segments, and a second fastener is disposed along the second side surface and is configured to secure the second side surface to a second of the pair of segments. The first and second fasteners limit movement of the first and second side surfaces in relation to the segments along a radial direction of the tire building drum.

In some embodiments, each of the first and second fasteners are defined by a tongue extending along and protruding from the respective first and second side surfaces. Each tongue is sized to be received within and engaged by a groove defined along the corresponding segment inner surface. In certain embodiments, the first and second fasteners cooperate to hold the panel outer surface flush with outer surfaces of the pair of segments. In certain embodiments, each end surface defines a beveled surface conforming to and extending between a beveled surface of at least one of the segments.

In several embodiments, the panel inner surface defines at least one fastener for securing the panel to the connector bracket. For example, in certain embodiments, the at least one fastener comprises a channel defined by the panel and extending between the panel end surfaces. The channel is dimensioned to receive and engage an insert defined along the connector bracket. In some embodiments, the at least one fastener further comprises a recess defined by the panel, the recess being dimensioned to receive and engage a dowel extending from the connector bracket. In some embodiments, the recess is disposed along the channel. In other embodiments, the at least one fastener further comprises a magnet disposed along the panel inner surface, the magnet being configured to magnetically engage the connector bracket.

According to several features of the present general inventive concept, a method for mounting a locking spacer on a tire building drum includes the operation of providing a locking spacer having an arcuate outer surface sized to extend between opposing inner surfaces of a pair of axially-aligned segments of a tire building drum at a given separation distance of the pair of axially-aligned segments to provide a continuous outer working surface of the tire building drum between the pair of axially-aligned segments. The provided locking spacer has opposite first and second side surfaces, each of the side surfaces defining a tongue sized to be received within and engaged by one of the grooves of the opposing inner surfaces of the pair of axially-aligned segments. In a further operation, the first and second sets of segments are separated beyond the given separation distance. An inner surface of the locking spacer is mounted to the connector bracket to position the locking spacer outer surface in axial alignment between the pair of axially-aligned segments with each tongue facing one of the grooves. The first and second sets of segments are repositioned to the given separation distance to allow each tongue to be slidably received within and engaged by one of the grooves.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a tire building drum including a plurality of locking spacers of one embodiment constructed in accordance with several features of the present invention;

FIG. 2 is a cross-sectional side view of the tire building drum and locking spacers of FIG. 1;

FIG. 3 is a partial perspective view of the tire building drum of FIG. 2, showing a close up view of one locking spacer exploded from the tire building drum;

FIG. 4 is a partial side view of the tire building drum and locking spacer of FIG. 2, showing the locking spacer exploded from the tire building drum; and

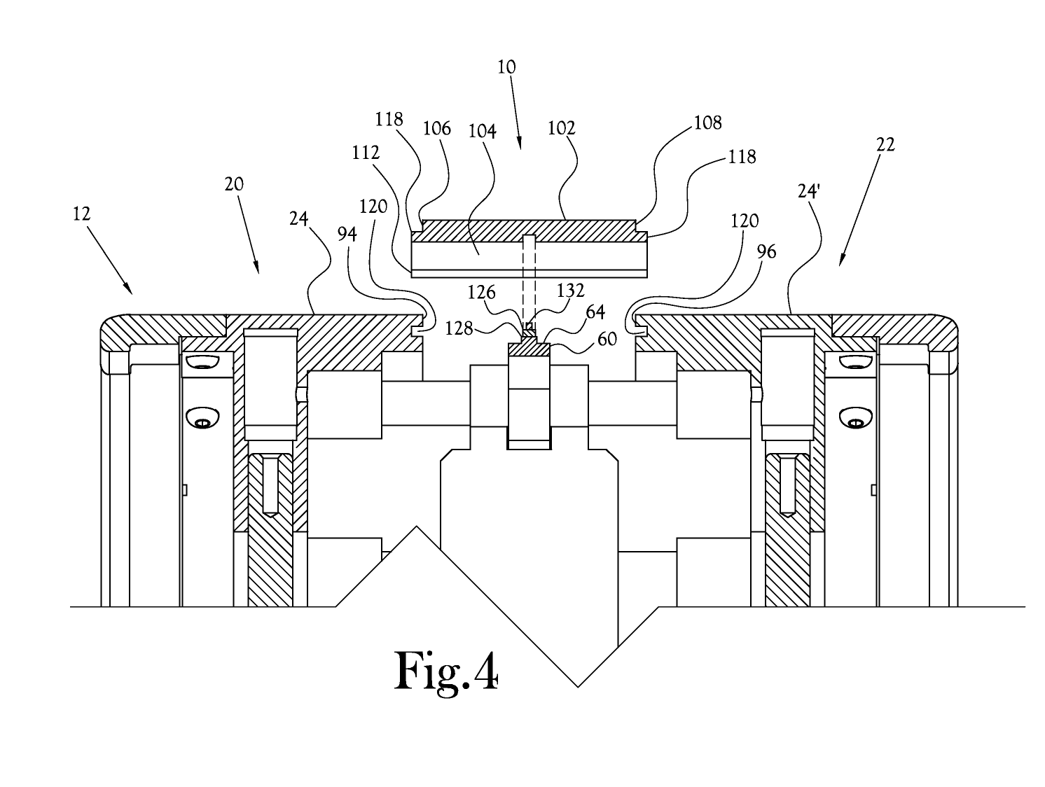

FIG. 5 is a partial side view of the tire building drum and locking spacer of FIG. 2.

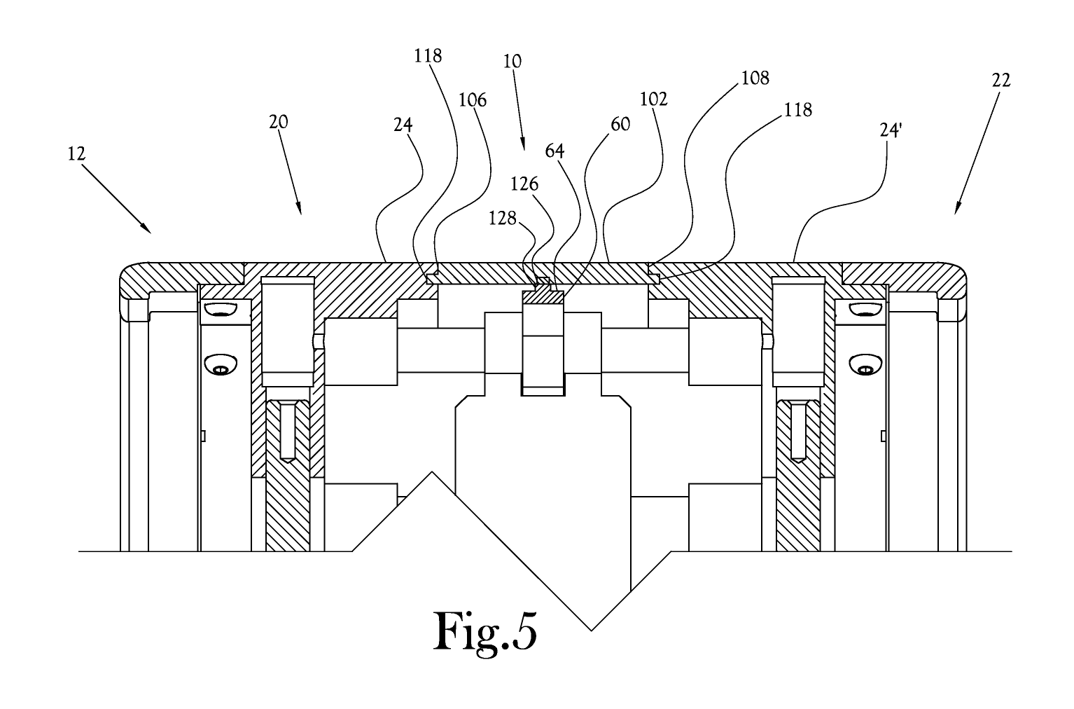

### DETAILED DESCRIPTION OF THE INVENTION

A locking spacer 10 and associated method is disclosed herein and in the various figures. The locking spacer 10 of the present invention provides an improvement in a prior art tire building drum 12 which is useful in the manufacture of vehicle tires.

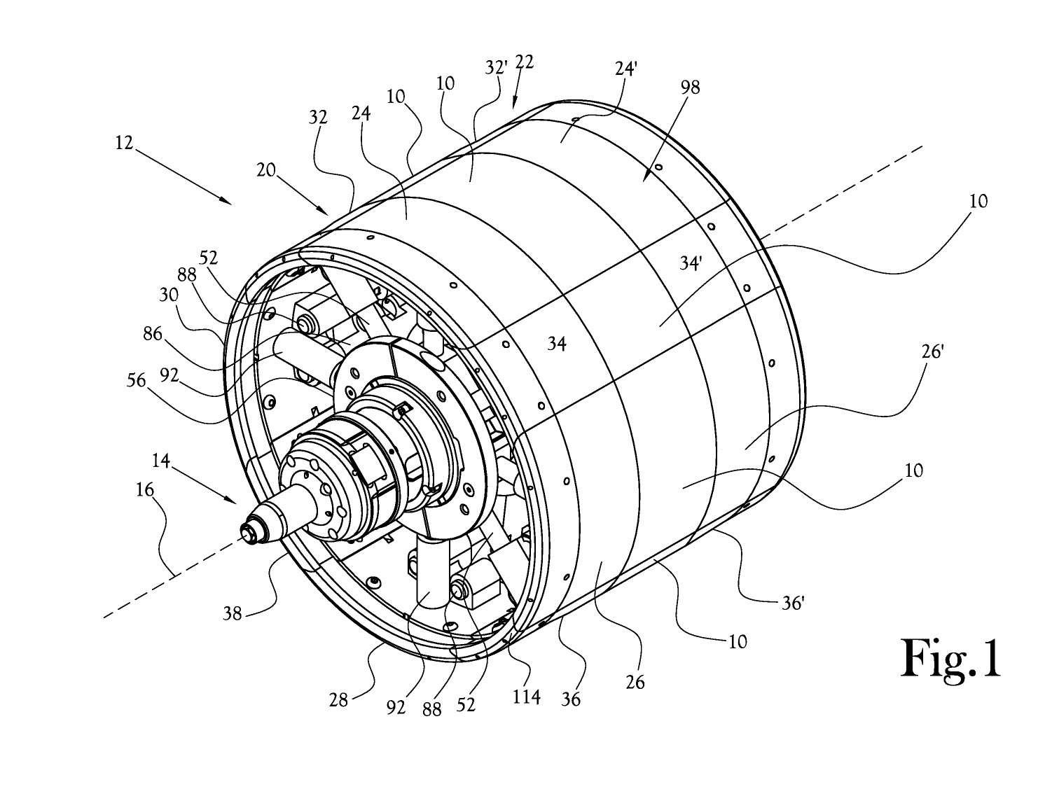

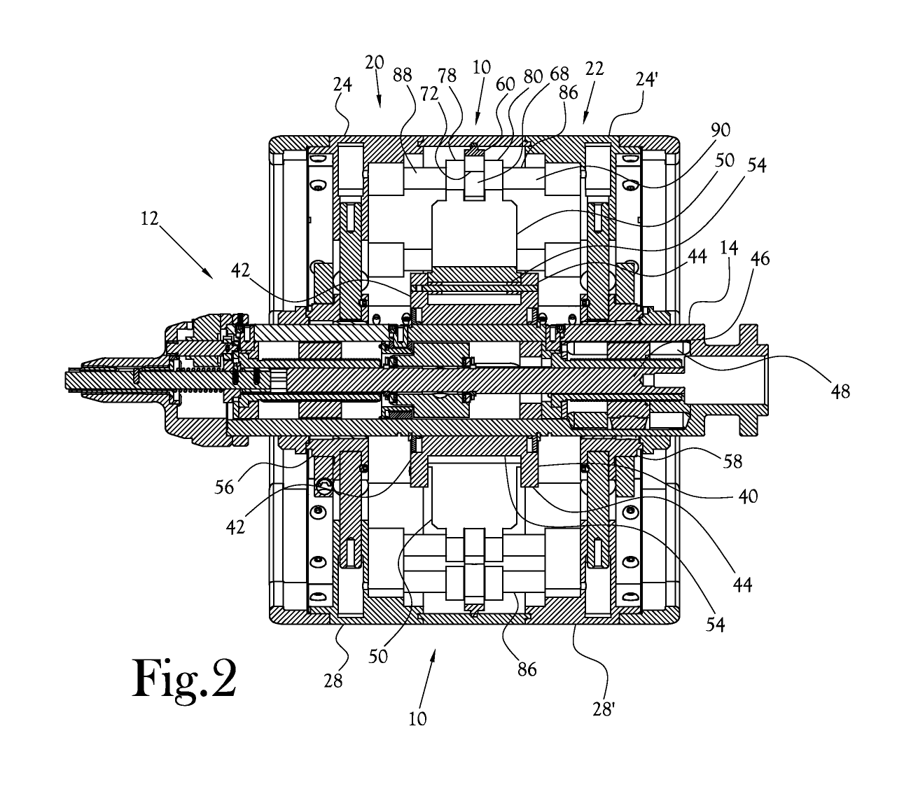

With initial reference to FIGS. 1 and 2, a tire building drum 12 is depicted. The tire building drum 12 is of the radially expandable and collapsible type wherein the drum includes a main shaft 14 which extends through the width of the drum and defines a rotational axis 16 of the drum. As indicated generally at 20 and 22, first and second sets of arcuate segments are provided, with each set 20, 22 of segments being disposed in a generally end-to-end cylindrical configuration on each of the opposite sides of a transverse centerplane of the main shaft 14. In the depicted drum 12, each set 20, 22 of segments includes four large segments, identified as 24, 26, 28, and 30 in the first set 20 of segments, and four small segments, identified as 32, 34, 36, and 38 in the first set 20 of segments. The corresponding large and small segments of the second set 22 of segments are identified by primed numerals. In each set 20, 22 of segments, the larger and smaller segments alternate in their position about the circumference of the drum 12. Furthermore, in the depicted drum 12, each large segment 24, 26, 28, 30 of the first set 20 is aligned in parallel relationship with one large segment 24′, 26′, 28′, 30′ of the second set 22 along an axial dimension of the drum 12. Likewise, each small segment 32, 34, 36, 38 of the first set 20 is aligned in parallel relationship with one small segment 32′, 34′, 36′, 38′ of the second set 22 along an axial dimension of the drum 12.

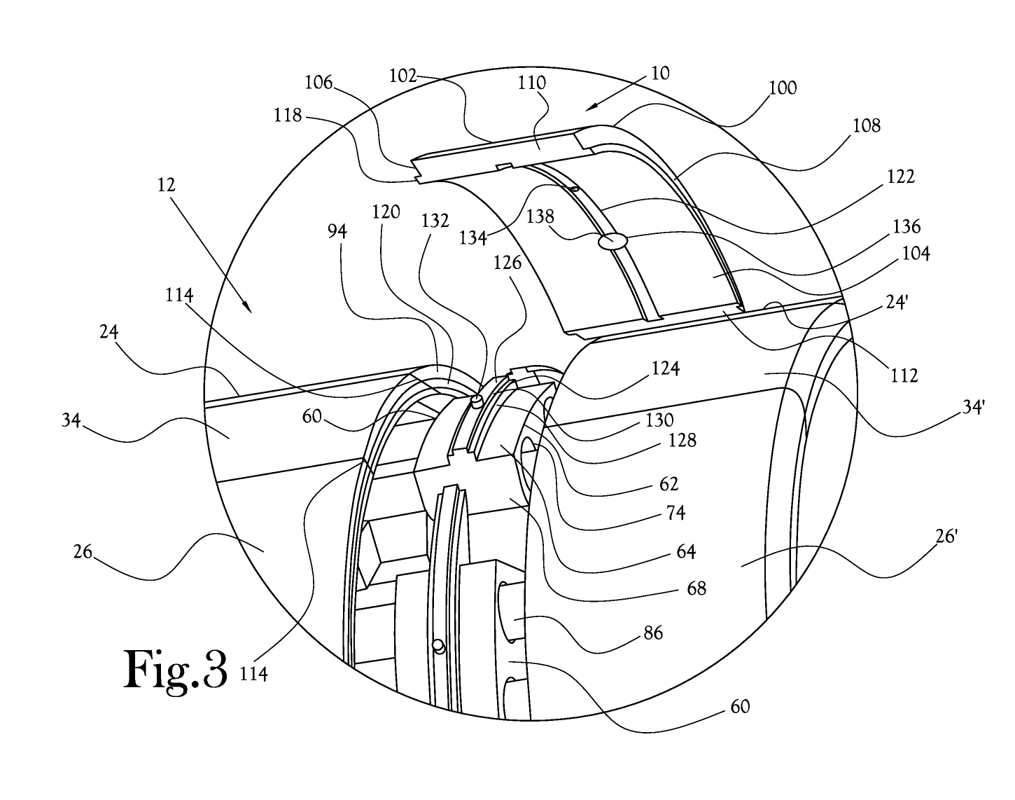

In the depicted drum 12, the main shaft 14 is fitted with an encircling spool-shaped hub 40 which includes a hollow cylindrical central body portion 54 and opposite end radial flanges 42, 44. Suitable mechanisms are provided between the hub 40 and the main shaft 14 to allow the hub 40 to be selectively rotatable about the shaft 14 between a first position and a second position by actuation of a drive rod 46 which is mounted within a hollow central cavity 48 extending axially along the main shaft 14. The hub 40 is fitted with a plurality of transition brackets 50, each of which is pivotally mounted at an inboard end thereof between the opposite radial flanges 42, 44 of the hub 40 as by respective pivot pins 54. A connector bracket 60 is pivotally mounted on the outboard end of each transition bracket 50. As shown in FIG. 3, in the depicted drum 12, each connector bracket 60 includes an elongated, generally arcuate body portion 62 having an outer surface 64, and a first lug 68 which projects from an inner surface 72 of the body portion 62. Referring to FIGS. 2 and 3, the first lug 68 of each connector bracket 60 is dimensioned to be received within an open space defined between second and third lugs 78, 80 provided on the outboard end of a respective transition bracket 50. Each of the lugs 68, 78, 80 is provided with a respective through bore 74, each of which is aligned axially of the drum, i.e., parallel to the main shaft 14, and in register with the through bores of adjacent lugs. A pin 86 is provided within each set of adjacent through bores 74, to pivotally mount the associated connector bracket 60 to its respective transition bracket 50. Furthermore, each pin 86 extends axially from its associated connector bracket 60 to provide opposite cantilevered ends 88, 90.

As shown in FIGS. 1 and 2, a pair of collars 56, 58 are provided encircling the main shaft 14 on opposite sides of the hub 40, with each collar 56, 58 being slidably, but non-rotatably, mounted along the main shaft 14. A plurality of rods 52 project radially outwardly from each collar 56, 58 at radially spaced apart locations about the collar. In the depicted drum 12, a plurality of hollow tubular sections 92 are provided, with one hollow tubular section 92 being mounted on an interior surface of each segment 24, 26, 28, 30, 32, 34, 36, 38 and each hollow tubular section 92 being slidably received over an outboard end of one of the rods 52. In this configuration, movement of each segment 24, 26, 28, 30, 32, 34, 36, 38 in relation to its associated collar 56, 58 is limited to radial inward and outward movement toward and away from the main shaft 14 of the drum 12. Furthermore, each segment 24, 26, 28, 30, 32, 34, 36, 38 is slidably and rotatably mounted along one of the opposite cantilevered ends 88, 90 of a pin 86. Thus, rotation of the hub 40 about the main shaft 14 results in radial expansion or collapse of the segments 24, 26, 28, 30, 32, 34, 36, 38 toward or away from the main shaft 14 of the drum 12. Moreover, suitable mechanisms are provided between the main shaft 14 and the collars 56, 58 to allow the collars to be selectively repositionable along the axis of the main shaft 14, thereby allowing the amount of separation between the sets 20, 22 of segments along an axial dimension of the drum 12 to be selectively adjusted. In this manner, the overall axial length of the drum 12 is adjusted. U.S. Pat. No. 6,390,166 provides further structural and operational information relating to this type of tire building drum 12 and is incorporated herein in its entirety by reference.

In one embodiment of the present invention, a plurality of locking spacers 10 constructed in accordance with several features of the present invention are provided to be removably secured along the outer surfaces 64 of the connector brackets 60 and to engage and extend between opposing inner edge surfaces 94, 96 of the segments forming the first and second sets 20, 22 of segments of the tire building drum 12, thereby providing a continuous, uniform outer working surface 98 of the tire building drum 12. In the depicted embodiment, one locking spacer 10 is provided to be secured along each connector bracket 60, and each locking spacer 10 is sized to extend fully between each axially-aligned pair of segments of the first and second sets 20, 22 of segments. For example, FIG. 3 shows a locking spacer 10 which is sized to extend fully between the inner edge surface 94 of the first large segment 24 of the first set 20 of segments and the inner edge surface 96 of the first large segment 24′ of the second set 22 of segments. It will be understood that additional locking spacers are provided to engage and extend between the axially-aligned first small segments 32, 32′, second large segments 26, 26′, and so forth about the circumference of the drum 12. Thus, upon separation of each pair of axially-aligned segments from adjacent segments during collapse of the tire building drum 12 (as is more fully described in U.S. Pat. No. 6,390,166), each locking spacer 10 remains engaged with and extends between its associated axially-aligned pair of segments. Furthermore, it will be understood that the locking spacers 10 may be sized such that a plurality of locking spacers 10 can be secured to each connector bracket 60 to span between each axially-aligned pair of segments of the drum 12 without departing from the spirit and scope of the present invention.

Referring specifically to FIG. 3, the locking spacer 10 of the illustrated embodiment is defined by a generally arcuate panel 100 having an outer surface 102, an inner surface 104, opposite first and second curved end surfaces 106, 108, respectively, and opposite first and second straight side surfaces 110, 112, respectively. As will be further discussed below, the inner surface 104 defines connecting means for removable attachment of the locking spacer 10 to the outer surface 64 of the connector bracket 60. It will be understood that when the locking spacer 10 is mounted on the connector bracket 60 of the drum 12, the curved end surfaces 106, 108 are oriented parallel to a plane normal to the rotational axis of the main shaft 14, and the side surfaces 110, 112 are oriented parallel to the rotational axis of the main shaft 14. As discussed above, in the illustrated embodiment, the first curved end surface 106 is of a length and arcuate shape suitable to register with the inner edge surface 94 of one of the segments of the first set 20 of segments of a tire building drum 12, such as for example the first large segment 24 of the first set 20. Likewise, the second curved end surface 108 is of a length and arcuate shape suitable to register with the inner edge surface 96 of that segment of the second set 22 of segments which is axially-aligned with and opposes the one segment, such as for example the first large segment 24′ of the second set 22. Each of the first and second side surfaces 110, 112 is of a sufficient length to allow the panel 100 to span between the associated axially-aligned opposing segments 24, 24′ at a given separation distance of the first and second sets 20, 22 of segments, such that the outer surface 102 of the locking spacer 10 defines a portion of the outer circumferential working surface 98 of the tire building drum 12 which is continuous between the outer surfaces of the axially-aligned opposing segments 24, 24′. To this extent, it will be understood that the length of the first and second side surfaces 110, 112, and thus the overall axial length of the locking spacer 10, may vary to facilitate the desired adjustable overall axial length of the outer circumferential working surface 98 of the tire building drum 12. Furthermore, it will be understood that numerous locking spacers 10 embodying numerous lengths of the first and second side surfaces 110, 112 may be provided for use with a single tire building drum 12 at incremental overall axial lengths of the tire building drum 12.

In certain embodiments, the side surfaces 110, 112 of each locking spacer 10 are contoured to follow a contour defined by the segments 24, 24′ adjacent the locking spacer 10. For example, in certain designs of tire building drums, such as the device disclosed in U.S. Pat. No. 6,390,166 and in the illustrated tire building drum 12, the side surfaces of each segment 24, 26, 28, 30, 32, 34, 36, 38 of the tire building drum 12 define a chamfer 114 to allow each segment side surface to matingly engage the adjacent side surfaces of adjacent segments to define a substantially continuous outer circumferential working surface 98 of the tire building drum 12, and further to allow greater ease of separation of adjacent segments during collapse of the tire building drum 12. Thus, in certain embodiments of the locking spacer 10, the first and second side surfaces 110, 112 of each locking spacer 10 are chamfered to match the chamfer 114 of their associated adjacent axially-aligned opposing segments 24, 24′. Similarly to the chamfer of the segments 24, 26, 28, 30, 32, 34, 36, 38 of the tire building drum 12, such chamfer of the first and second axial edge surfaces 110, 112 of each locking spacer 10 promotes mating engagement of the respective side surfaces 110, 112 of adjacent locking spacers 10, thereby promoting a substantially continuous outer circumferential working surface 98 of the tire building drum 12 between the first and second sets 20, 22 of segments, and further allows greater ease of separation of adjacent locking spacers 10 during collapse of the tire building drum 12.

In several embodiments, the first and second curved end surfaces 106, 108 and the inner surface 104 of the panel 100 each define engagement means for securing the locking spacer 10 in place against the outer surface 64 of the connector bracket 60 and between the segment inner edge surfaces 94, 96 of the associated axially-aligned opposing segments 24, 24′. In several embodiments, the engagement means further serve to lock the locking spacer 10 against movement in relation to the associated segments 24, 24′. For example, in the illustrated embodiment, each of the first and second curved end surfaces 106, 108 defines a tongue 118 disposed along a length of the curved end surface 106, 108 and projecting from the curved end surface 106, 108 along an axial dimension of the drum 12. Each tongue 118 is dimensioned to be snugly slidably received within an appropriate groove 120 defined by a corresponding adjacent inner edge surface 94, 96 of one of the associated axially-aligned opposing segments 24, 24′. Thus, in this embodiment, radial movement of the first and second curved end surfaces 106, 108 in relation to the associated axially-aligned opposing segments 24, 24′ is limited.

It will be understood that engagement of the tongues 118 of the locking spacer 10 of the present embodiment within the grooves 120 defined by the inner edge surfaces 94, 96 of the segments 24, 24′ may be achieved by first axially separating the segments 24, 24′ as discussed above to a distance sufficient to allow the locking spacer 10 to be positioned in axial alignment between the segments 24, 24′ with each tongue 118 facing a cooperating groove 120. Upon positioning the locking spacer 10 thusly, the segments 24, 24′ may thereafter be brought together a distance sufficient to allow each tongue 118 to be received within a cooperating groove 120, thereby locking the locking spacer 10 between the segments 24, 24′.

In several embodiments, the inner surface 104 of the panel 100 is adapted to be releasably engaged by the outer surface 64 of the connector bracket 60 such that the panel 100 is held along the outer surface 64 of the connector bracket 60 in axial alignment between the axially-aligned opposing segments 24, 24′. For example, in the illustrated embodiment, the panel 100 defines an arcuate channel 122 extending along the inner surface 104 between the side surfaces 110, 112. The channel 122 is dimensioned to snugly slidably receive therein at least a portion of an appropriate insert 124 defined along the outer surface 64 of the connector bracket 60. For example, in the illustrated embodiment, each connector bracket outer surface 64 defines an insert 124 that includes an elongated base portion 128 extending radially outwardly from the connector bracket 60 and defining a radially-outwardly facing arcuate bearing surface 130. An elongated ridge 126 extends radially outwardly along a central portion of the bearing surface 130 and is sized and shaped to be snugly slidably received within the channel 122 to secure the locking spacer 10 against axial slidable and rotational movement in relation to the drum 12 and to allow the panel inner surface 104 to establish intimate contact with the bearing surface 130. The base portion 128 extends outwardly from the outer surface 64 of the connector bracket 60 a sufficient distance such that the intimate contact of the bearing surface 130 against the panel inner surface 104 positions the panel 100 at a distance radially outwardly from the connector bracket 60 sufficient to align the locking spacer 10 between its associated segments 24, 24′.

In several embodiments, the connector bracket 60 defines at least one dowel 132 projecting radially outwardly therefrom. Each dowel 132 is dimensioned to be received within an appropriate recess 134 defined by the panel 100 along the panel inner surface 104 to further secure the panel 100 against movement in relation to the connector bracket 60. In the illustrated embodiment, a dowel 132 projects radially outwardly from the ridge 126 and is adapted to be received within and engaged by a corresponding bore 134 defined along the channel 122 to limit the locking spacer 10 against slidable movement along the insert 124. However, those of skill in the art will recognize that any number of dowels 132 may be employed and positioned at numerous locations along the connector bracket 60 with corresponding bores 134 defined along the panel 100 without departing from the spirit and scope of the present invention.

In several embodiments, the locking spacer 10 includes a retaining mechanism which is configured to releasably secure the panel 100 against separation from the connector bracket 60. For example, in the illustrated embodiment, the panel 100 defines at least one recess 136 along the channel 122 defined by the interior surface 104. A magnet 138 is fixed within the recess 136 and is positioned to magnetically engage the connector bracket 60 when the locking spacer 10 is positioned with the insert 124 received within the channel 122. Thus, upon receipt of the insert 124 within the channel 122, the magnet 138 cooperates with the cooperating insert 124 and channel 122, and with the cooperating dowel 132 and bore 134, to fix the panel 100 in relation to the connector bracket 60.

An associated method for installing the locking spacer 10 is further disclosed herein. In one embodiment of a method for installing the locking spacer 10, a tire building drum 12 is provided. It will be understood that the provided tire building drum 12 is of the type discussed above wherein the tire building drum includes two sets 20, 22 of segments, with each set 20, 22 being disposed in a generally end-to-end cylindrical configuration, with the sets 20, 22 being disposed in a coaxial configuration with respect to one another and being axially repositionable with respect to one another, and with each segment 24 of one set 20 being axially-aligned with a segment 24′ of another set 22. It will further be understood that the provided tire building drum 12 includes at least one connector bracket 60 positioned between each axially-aligned pair of segments 24, 24′ as discussed above. A locking spacer 10 as discussed above is also provided. In the present embodiment of the method, the sets 20, 22 of segments are separated along the axial dimension of the tire building drum 12 to a distance sufficient to allow the locking spacer 10 to be positioned between a pair of axially-aligned segments 24, 24′ and to allow the locking spacer 10 to be secured to the connector bracket 60. The locking spacer 10 is then positioned against the connector bracket 60 in axial alignment between the segments 24, 24′, that is, with the curved end surfaces 106, 108 of the locking spacer 10 facing the inner edge surfaces 94, 96 of the axially-aligned pair of segments 24, 24′, with the side surfaces 110, 112 of the locking spacer 10 parallel with the axial dimension of the tire building drum 12, and with the outer surface 102 of the locking spacer 10 in coplanar relationship with the outer surfaces of the axially-aligned pair of segments 24, 24′. In embodiments in which the inner surface 104 of the locking spacer 10 defines attachment means for securing to the connector bracket 60, the locking spacer 10 is secured to the connector bracket 60. Thereafter, the sets 20, 22 of segments are repositioned toward the locking spacer 10 to allow engagement between the curved end surfaces 106, 108 of the locking spacer 10 and the inner edge surfaces 94, 96 of the axially-aligned pair of segments 24, 24′.

From the foregoing description, it will be recognized by those skilled in the art that a locking spacer 10 has been provided for use between axially-aligned segments 24, 24′ of a tire building drum 12 which provides increased stability of the locking spacer 10 in relation to the segments 24, 24′. Furthermore, it will be recognized that the locking spacer 10 provides a spacer for use with a tire building drum 12 which can be more quickly and easily mounted on and removed from a tire building drum 12 than several spacer designs known in the art.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A locking spacer for use with a tire building drum having a pair of arcuate segments aligned in parallel-planar relationship along an axial dimension of the tire building drum, the pair of segments having opposing inner surfaces, the segments being repositionable with respect to one another along an axial dimension of the tire building drum, the tire building drum further having a connector bracket disposed between and radially inwardly of the pair of segments, said locking spacer comprising:
an arcuate panel having an outer surface, an inner surface, opposite first and second curved side surfaces, and opposite first and second straight end surfaces, said panel being sized and shaped to span between and extend along the opposing inner surfaces of the segments;
a first fastener disposed along said first side surface and configured to secure said first side surface to a first of the pair of segments; and
a second fastener disposed along said second side surface and configured to secure said second side surface to a second of the pair of segments;
whereby said first and second fasteners limit movement of said first and second side surfaces in relation to the segments along a radial direction of the tire building drum.

2. The locking spacer of claim 1, each of said first and second fasteners being defined by a tongue extending along and protruding from said respective first and second side surfaces, each said tongue being sized to be received within and engaged by a groove defined along the corresponding segment inner surface.

3. The locking spacer of claim 1, said first and second fasteners cooperating to hold said panel outer surface flush with outer surfaces of the pair of segments.

4. The locking spacer of claim 1, said panel inner surface defining at least one fastener for securing said panel to said connector bracket.

5. The locking spacer of claim 4, said at least one fastener comprising a channel defined by said panel and extending between said panel end surfaces, said channel being dimensioned to receive and engage an insert defined along the connector bracket.

6. The locking spacer of claim 5, said at least one fastener further comprising a recess defined by said panel, said recess being dimensioned to receive and engage a dowel extending from the connector bracket.

7. The locking spacer of claim 6, said recess being disposed along said channel.

8. The locking spacer of claim 6, said at least one fastener further comprising a magnet disposed along said panel inner surface, said magnet being configured to magnetically engage the connector bracket.

9. The locking spacer of claim 1, each said end surface defining a beveled surface conforming to and extending between a beveled surface of at least one of the segments.

10. An improvement in a tire building drum having first and second sets of segments, the segments of each set having arcuate outer surfaces disposed in an end-to-end cylindrical configuration about a central axis of the tire building drum to collectively define an outer circumferential surface of the tire building drum, each segment of the first set being aligned along an axial dimension of the tire building drum with a segment of the second set to define a pair of axially-aligned segments having opposing inner surfaces, each of the first and second sets of segments being repositionable with respect to one another along the central axis of the tire building drum, wherein separation of the first and second sets of segments defines a void between each pair of axially-aligned segments, the tire building drum further having at least one connector bracket disposed proximate each void between and radially inwardly of each pair of axially-aligned segments, the improvement comprising:
a plurality of locking spacers, each said locking spacer having an arcuate outer surface sized to extend between opposing inner surfaces of the pair of axially-aligned segments to provide a continuous outer working surface of the tire building drum between the pair of axially-aligned segments, each said locking spacer further having opposite first and second end surfaces extending between the opposing inner surfaces of the pair of axially-aligned segments and first and second side surfaces extending along the opposing inner surfaces of the pair of axially-aligned segments;
a first connector configured to secure said first side surface adjacent a first of the opposing inner surfaces of the pair of axially-aligned segments; and
a second connector configured to secure said second side surface adjacent a second of the opposing inner surfaces of the pair of axially-aligned segments;
whereby said first and second connectors limit movement of said first and second side surfaces in relation to the pair of axially-aligned segments along a radial direction of the tire building drum.

11. The tire building drum of claim 10, each said outer surface of each said locking spacer extending flush between the outer surfaces of the associated pair of axially-aligned segments.

12. The tire building drum of claim 10, each said first and second connector defining a tongue and groove connection.

13. The tire building drum of claim 12, each of said first and second side surfaces defining a tongue extending along the respective side surface and protruding therefrom, each said tongue being sized to be received within and engaged by a groove defined along one of the opposing inner surfaces of the pair of axially-aligned segments.

14. The tire building drum of claim 10, said improvement further comprising a third connector configured to secure an inner surface of said locking spacer to the connector bracket.

15. The tire building drum of claim 14, said third connector defining a tongue and groove connection.

16. The tire building drum of claim 15, said third connector comprising:
a channel defined along said locking spacer inner surface and extending between said end surfaces; and
an insert defined along the connector bracket, said channel being dimensioned to receive and engage said insert.

17. The tire building drum of claim 16, said third connector further comprising a recess defined by said locking spacer along said channel, said recess being dimensioned to receive and engage a dowel extending from said insert.

18. The tire building drum of claim 14, said third connector comprising a magnet disposed along said locking spacer inner surface, said magnet being configured to magnetically engage the connector bracket.

19. The tire building drum of claim 10, each said locking spacer end surface defining a beveled surface conforming to and extending between a surface of each of the pair of axially-aligned segments.

20. A method for mounting a spacer on a tire building drum having first and second sets of segments, the segments of each set having arcuate outer surfaces disposed in an end-to-end cylindrical configuration about a central axis of the tire building drum to collectively define an outer circumferential surface of the tire building drum, each segment of the first set being aligned along an axial dimension of the tire building drum with a segment of the second set to define a pair of axially-aligned segments having opposing inner surfaces, each of the opposing inner surfaces defining a groove extending along a length thereof, each of the first and second sets of segments being repositionable with respect to one another along the central axis of the tire building drum, wherein separation of the first and second sets of segments defines a void between each pair of axially-aligned segments, the tire building drum further having at least one connector bracket disposed proximate each void between and radially inwardly of each pair of axially-aligned segments, the method comprising:
providing a locking spacer having an arcuate outer surface sized to extend between the opposing inner surfaces of a pair of axially-aligned segments at a given separation distance of the pair of axially-aligned segments to provide a continuous outer working surface of the tire building drum between the pair of axially-aligned segments, the locking spacer having opposite first and second side surfaces, each of the side surfaces defining a tongue sized to be received within and engaged by one of the grooves of the opposing inner surfaces of the pair of axially-aligned segments;
separating the first and second sets of segments beyond the given separation distance;
mounting an inner surface of the locking spacer to the connector bracket to position the locking spacer outer surface in axial alignment between the pair of axially-aligned segments with each tongue facing one of the grooves; and
repositioning the first and second sets of segments to the given separation distance to allow each tongue to be slidably received within and engaged by one of the grooves.
